(19) United States
(12) Patent Application Publication
(10) Pub. No.: US 2013/0091514 A1
(43) Pub. Date: Apr. 11, 2013

(54) SYSTEM, SERVER, TERMINAL APPARATUS, AND METHOD

(71) Applicants: Koji Ishii, Chiyoda-ku (JP); Nobuaki Sasao, Chiyoda-ku (JP)

(72) Inventors: Koji Ishii, Chiyoda-ku (JP); Nobuaki Sasao, Chiyoda-ku (JP)

(73) Assignee: NTT DOCOMO, INC, Tokyo (JP)

(21) Appl. No.: 13/704,009

(22) PCT Filed: May 23, 2011
(86) PCT No.: PCT/JP2011/061766

§ 371 Date: Dec. 13, 2012

(30) Foreign Application Priority Data
Jun. 25, 2010 (JP) 2010-145546

(51) Int. Cl. H04N 21/254; H04N 21/466

(52) U.S. Cl. CPC H04N 21/2541; H04N 21/4667
USPC 725/5; 725/14

(57) ABSTRACT

A system includes a broadcast server performing a charging process for a digital broadcasting program and a terminal apparatus receiving the program. The terminal apparatus includes a reception condition measuring unit measuring a reception condition of the program, a reception condition reporting unit reporting the reception condition, and a receiving unit receiving, from the broadcast server, information for viewing file-based content of the program to be delivered from a broadcasting apparatus. The broadcast server includes a reception condition determining unit determining whether it is necessary to make the program viewable based on the reception condition of the program reported by the terminal apparatus, a view permission information generating unit generating the information for viewing the file-based content of the program when it is necessary to make the program viewable, and a transmitting unit sending the information for viewing the file-based content of the program.

### TECHNICAL FIELD

The present invention relates to a broadcasting system.

### BACKGROUND ART

In Japan, terrestrial analog television broadcasting ends and is switched to terrestrial digital television broadcasting in 2011. In addition to terrestrial analog broadcasting, satellite analog broadcasting (BS analog broadcasting) ends completely at the same time.

When the terrestrial television broadcasting is completely digitized, parts of the VHF band and the UHF band (90 MHz-108 MHz, 170 MHz-222 MHz, and 710 MHz-770 MHz) being currently used for the terrestrial analog television broadcasting become vacant. It is planned to provide multimedia broadcasting services for mobile terminals using the vacant frequency bands. For example, in the high band of the VHF band, Integrated Services Digital Broadcasting-Terrestrial for mobile multimedia (ISDB-Tmm) is to be provided.

The multimedia broadcasting services include fee-based broadcasting services and free broadcasting services. The fee-based broadcasting services include a streaming broadcasting service and a storage-type broadcasting service. In the storage-type broadcasting service, file-based content is delivered.

In the streaming broadcasting service, the user may be charged for each program. The method of charging for each program is called Pay Per View (PPV).

In a prepaid method, the user can view a PPV program by paying the charge for the PPV program in advance.

In a pay-later method, the user pays the charge for a PPV program after viewing the PPV program. In the pay-later method, for example, a view history of viewing PPV programs is stored in a broadcast receiver. The view history is reported to the broadcaster at predetermined timing, and the broadcaster charges the user based on the view history. For example, the view history may be reported to the broadcaster at the end of the month. In the pay-later method, the user is not charged for PPV programs that the user has not viewed. However, even when the user has viewed only a part of a program, the user is charged for the program. There is also a method of determining the amount of charge based on the amount of time PPV programs have been viewed.

### RELATED-ART DOCUMENTS

### Patent Document

[Patent document 1] Japanese Laid-Open Patent Publication No. 2003-153225

### Non-Patent Document

[Non-Patent document 1] ARIB-STD B25

### DISCLOSURE OF INVENTION

### Problems to be Solved by the Invention

With the prepaid method where the user pays the charge for a PPV program in advance, there may be a case where the user cannot actually and fully view the PPV program after paying the charge. This may happen since programs are wirelessly transmitted in the streaming broadcasting service and the reception conditions of the programs change.

In the pay-later method, the user is not charged for PPV programs that the user has not viewed. However, even when the user has viewed only a part of a program, the user is charged for the program.

With the method of determining the amount of charge based on the amount of time PPV programs have been viewed, the user is not charged for a program that the user has not been able to view due to a change in the reception condition. Still in this case, however, the desire of the user to view the program is not satisfied. Also, since the user does not view programs when the reception condition is poor, the broadcaster cannot charge for the programs delivered while the reception condition is poor. This in turn reduces the revenue of the broadcaster. Further, the method of determining the amount of charge based on the amount of time PPV programs have been viewed is not applicable to the prepaid method.

One object of the present invention is to solve or reduce the above described problems in the related art, and to provide a system, a server, a terminal apparatus, and a method that make it possible to make charged content available to the user regardless of the reception condition of streaming.

### Means for Solving the Problems

An aspect of this disclosure provides a system including a broadcast server configured to perform a charging process for a program of digital broadcasting, and a terminal apparatus configured to receive the program of digital broadcasting. The terminal apparatus includes a reception condition measuring unit configured to measure a reception condition of the program of digital broadcasting, a reception condition reporting unit configured to report the reception condition of the program measured by the reception condition measuring unit to the broadcast server, and a receiving unit configured to receive, from the broadcast server, information for viewing file-based content of the program to be delivered from a broadcasting apparatus. The broadcast server includes a reception condition determining unit configured to determine whether it is necessary to make the program viewable based on the reception condition of the program reported by the terminal apparatus, a view permission information generating unit configured to generate the information for viewing the file-based content of the program when the reception condition determining unit determines that it is necessary to make the program viewable, and a transmitting unit configured to send the information for viewing the file-based content of the program generated by the view permission information generating unit.

An aspect of this disclosure provides a system including a broadcast server configured to perform a charging process for a program of digital broadcasting, and a terminal apparatus configured to receive the program of digital broadcasting. The terminal apparatus includes a reception condition measuring unit configured to measure a reception condition of the program of digital broadcasting, a reception condition determining unit configured to determine whether it is necessary to request to make the program viewable based on the reception condition of the program measured by the reception condition measuring unit, a program information reporting unit configured to report information indicating the program to the broadcast server when the reception condition determining unit determines that it is necessary to request to make the program viewable, and a receiving unit configured to receive, from the broadcast server, information for viewing file-based content of the program to be delivered from a broadcasting apparatus. The broadcast server includes a view permission information generating unit configured to generate the information for viewing the file-based content of the program based on the information that indicates the program and is reported by the program information reporting unit, and a transmitting unit configured to send the information for viewing the file-based content of the program generated by the view permission information generating unit.

An aspect of this disclosure provides a broadcast server that performs a charging process for a program of digital broadcasting. The broadcast server includes a reception condition determining unit configured to determine whether it is necessary to make the program viewable based on a reception condition reported by a terminal apparatus; a view permission information generating unit configured to generate information for viewing file-based content of the program when the reception condition determining unit determines that it is necessary to make the program viewable; and a transmitting unit configured to send the information for viewing the file-based content of the program generated by the view permission information generating unit. The terminal apparatus is configured to measure the reception condition of the program, report the reception condition to the broadcast server, and receive, from the broadcast server, the information for viewing the file-based content of the program to be delivered from a broadcasting apparatus.

An aspect of this disclosure provides a broadcast server that performs a charging process for a program of digital broadcasting. The broadcast server includes a view permission information generating unit configured to generate information for viewing file-based content of the program based on information that indicates the program and is reported by a terminal apparatus; and a transmitting unit configured to send the information for viewing the file-based content of the program generated by the view permission information generating unit. The terminal apparatus is configured to measure the reception condition of the program, determine whether it is necessary to request to make the program viewable based on the reception condition of the program, report the information indicating the program to the broadcast server when it is necessary to request to make the program viewable, and receive, from the broadcast server, the information for viewing the file-based content of the program to be delivered from a broadcasting apparatus.

An aspect of this disclosure provides a terminal apparatus for receiving digital broadcasting. The terminal apparatus includes a reception condition measuring unit configured to measure a reception condition of a program of digital broadcasting; a reception condition reporting unit configured to report the reception condition of the program measured by the reception condition measuring unit to a broadcast server; and a receiving unit configured to receive, from the broadcast server, information for viewing file-based content of the program to be delivered from a broadcasting apparatus. The broadcast server is configured to determine whether it is necessary to make the program viewable based on the reception condition of the program reported by the terminal apparatus, generate the information for viewing the file-based content of the program when it is necessary to make the program viewable, and send the information for viewing the file-based content of the program.

An aspect of this disclosure provides a terminal apparatus for receiving digital broadcasting. The terminal apparatus includes a reception condition measuring unit configured to measure a reception condition of a program of digital broadcasting; a reception condition determining unit configured to determine whether it is necessary to request to make the program viewable based on the reception condition of the program measured by the reception condition measuring unit; a program information reporting unit configured to report information indicating the program to a broadcast server when the reception condition determining unit determines that it is necessary to request to make the program viewable; and a receiving unit configured to receive, from the broadcast server, information for viewing file-based content of the program to be delivered from a broadcasting apparatus. The broadcast server is configured to generate the information for viewing the file-based content of the program based on the information that indicates the program and is reported by the terminal apparatus, and send the information for viewing the file-based content of the program.

An aspect of this disclosure provides a method for a system including a broadcast server that performs a charging process for a program of digital broadcasting and a terminal apparatus that receives the program of digital broadcasting. The method includes steps performed by the terminal apparatus that include a reception condition measuring step of measuring a reception condition of the program of digital broadcasting, a reception condition reporting step of reporting the reception condition of the program measured in the reception condition measuring step to the broadcast server, and a receiving step of receiving, from the broadcast server, information for viewing file-based content of the program to be delivered from a broadcasting apparatus. The method also includes steps performed by the broadcast server that include a reception condition determining step of determining whether it is necessary to make the program viewable based on the reception condition of the program reported by the terminal apparatus, a view permission information generating step of generating the information for viewing the file-based content of the program when it is determined in the reception condition determining step that it is necessary to make the program viewable, and a transmitting step of sending the information for viewing the file-based content of the program generated in the view permission information generating step.

An aspect of this disclosure provides a method for a system including a broadcast server that performs a charging process for a program of digital broadcasting and a terminal apparatus that receives the program of digital broadcasting. The method includes steps performed by the terminal apparatus that include a reception condition measuring step of measuring a reception condition of the program of digital broadcasting, a reception condition determining step of determining whether it is necessary to request to make the program viewable based on the reception condition of the program measured in the reception condition measuring step, a program information reporting step of reporting information indicating the program to the broadcast server when it is determined in the reception condition determining step that it is necessary to request to make the program viewable, and a receiving step of receiving, from the broadcast server, information for viewing file-based content of the program to be delivered from a broadcasting apparatus. The method also includes steps performed by the broadcast server that include a view permission information generating step of generating the information for viewing the file-based content of the program based on the information that indicates the program and is reported in the program information reporting step, and a transmitting step of sending the information for viewing the file-based content of the program generated in the view permission information generating step.

### Advantageous Effect of the Invention

This disclosure provides a system, a server, a terminal apparatus, and a method that make it possible to make charged content available to the user regardless of the reception condition of streaming.

### BRIEF DESCRIPTION OF THE DRAWINGS

FIG. 1 is a drawing illustrating an exemplary system according to an embodiment;

FIG. 2 is a functional block diagram of a broadcast server according to an embodiment;

FIG. 3 is a table illustrating an exemplary view right used in a system according to an embodiment;

FIG. 4 is a flowchart illustrating operations of a system according to an embodiment;

FIG. 5 is a drawing illustrating an exemplary system according to an embodiment;

FIG. 6 is a functional block diagram of a broadcast server according to an embodiment; and

FIG. 7 is a flowchart illustrating operations of a system according to an embodiment.

### DESCRIPTION OF EMBODIMENTS

Preferred embodiments of the present invention are described below with reference to the accompanying drawings.

Throughout the accompanying drawings, the same reference numbers are used for components having the same functions, and overlapping descriptions of those components are omitted.

### Embodiment

### <System>

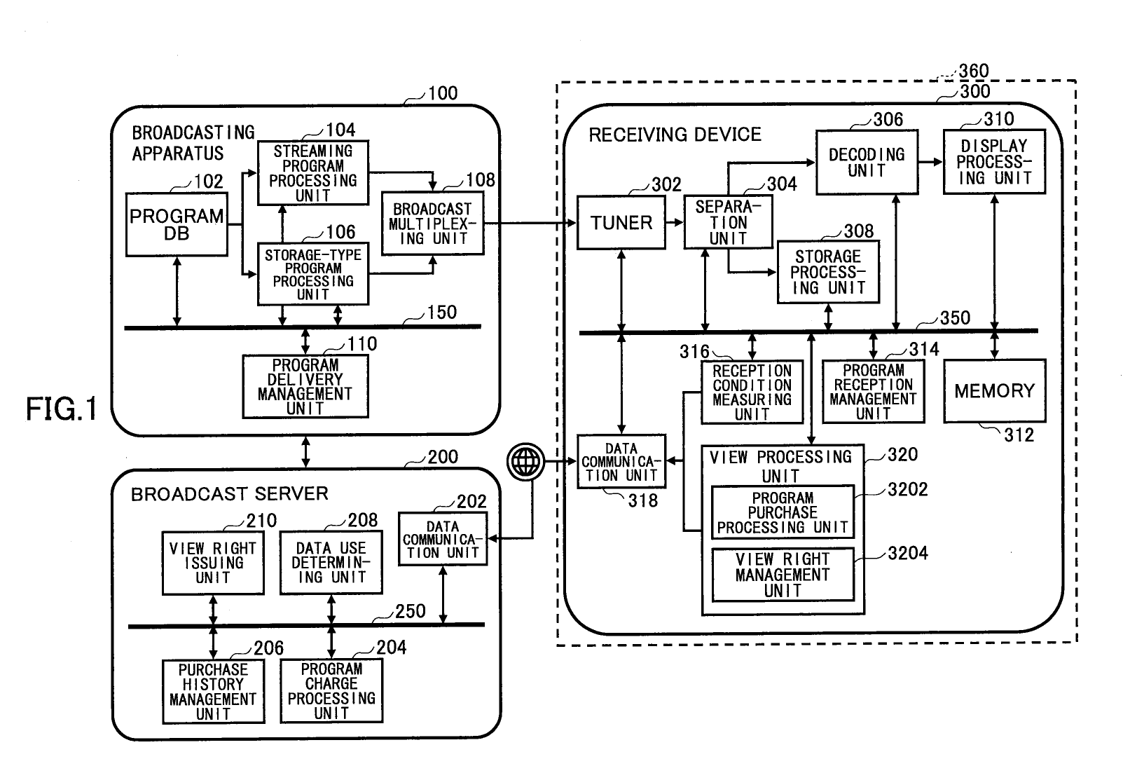

FIG. 1 is a drawing illustrating an exemplary system according to an embodiment. This system provides a broadcasting service. The broadcasting service may be provided as a fee-based service. Also, the fee-based service may be a prepaid service.

The system includes a broadcasting apparatus 100. The broadcasting apparatus 100 delivers programs. The programs may be paid for in advance under a PPV scheme. Alternatively, the programs may be paid for after delivery.

The system also includes a receiving device 300. The receiving device 300 may be provided, for example, in a terminal apparatus 360, a mobile terminal, or a personal digital assistant (PDA). The terminal apparatus 360 may be implemented by a personal computer (PC).

The receiving device 300 receives multimedia broadcasts delivered by the broadcasting apparatus 100. The multimedia broadcasts may include programs that can be received after PPV payment. The multimedia broadcasts may also include programs that can be received before payment. The multimedia broadcasts may be delivered as streaming broadcasts. When a program is received and viewed by the user, the receiving device 300 measures the reception condition of the program. Also, the reception condition of a program may be measured when the program is received and recorded. In an embodiment described below, it is assumed that a program is received after PPV payment. However, a program may be delivered before payment.

After a program ends, the receiving device 300 sends, to a broadcast server 200, an ID (hereafter referred to as a “PPV program ID”) of the program and a reception condition of the program corresponding to the PPV program ID. The PPV program ID and the reception condition may be sent via a two-way network. The two-way network indicates a network where both transmission from the receiving device 300 to the broadcast server 200 and transmission from the broadcast server 200 to the receiving device 300 are possible. Examples of the network may include the Internet and a mobile communication network. The mobile communication network may be used when the receiving device 300 is provided in a mobile terminal.

When the broadcast server 200 determines that the reception condition is poor, the receiving device 300 receives a view right and a delivery schedule of the program corresponding to the PPV program ID from the broadcast server 200. According to the delivery schedule received from the broadcast server 200, the receiving device 300 receives file-based content of the program corresponding to the PPV program ID. The file-based content of the program corresponding to the PPV program ID is delivered by the broadcasting apparatus 100. The file-based content is stored in the receiving device 300. When the file-based content is completely stored in the receiving device 300, the user plays the file-based content corresponding to the PPV program ID using the view right and thereby views the program.

The system includes the broadcast server 200. The broadcast server 200 is connected to the broadcasting apparatus 100. For example, the broadcast server 200 and the broadcasting apparatus 100 may be connected to each other via a network. Examples of the network may include the Internet. Alternatively, the broadcast server 200 and the broadcasting apparatus 100 may be connected to each other via a line. When receiving the PPV program ID and the reception condition of the program corresponding to the PPV program ID from the receiving device 300, the broadcast server 200 determines whether the program corresponding to the PPV program ID has been purchased by the receiving device 300. If the program has been purchased by the receiving device 300, the broadcast server 200 determines, based on the reception condition, whether it is necessary to enable the user to view the program again. When it is necessary to enable the user to view the program again, the broadcast server 200 generates a view right necessary to view the program delivered as file-based content and a delivery schedule of the file-based content. The delivery schedule may be obtained from a program delivery management unit 110 of the broadcasting apparatus 100. The broadcast server 200 sends the view right and the delivery schedule to the receiving device 300.

### <Broadcasting Apparatus>

The broadcasting apparatus 100 includes a program database (DB) 102. The program database 102 stores programs to be broadcast. For example, the program database 102 stores program IDs in association with program data.

The broadcasting apparatus 100 includes a streaming program processing unit 104. The streaming program processing unit 104 is connected to the program DB 102. Under the control of the program delivery management unit 110, the streaming program processing unit 104 obtains a program from the program DB 102 according to a program delivery schedule. The streaming program processing unit 104 encodes the program obtained from the program DB 102 for streaming broadcasting. For example, for multimedia broadcasting, the streaming program processing unit 104 may generate an MPEG-2 transport stream (MPEG-2 TS). An elementary stream (ES) is divided and packetized to generate a packetized elementary stream (PES). The elementary stream may contain video or audio data. Examples of audio data include voice data. Each packetized elementary stream packet is divided. Packets obtained by dividing the packetized elementary stream packet may be called transport (TS) packets. For example, the packetized elementary stream packet is divided into packets with a fixed length of 188 bytes. A sequence of transport packets forms a transport stream. For example, each transport packet in the transport stream includes a packet identifier (PID). The packet identifier may be represented by 13 bits. The packet identifier is used to identify information contained in the transport packet. For example, transport streams containing the same video or voice data include the same packet identifier. Therefore, the receiving device 300 can assemble transport streams into the original packetized elementary stream based on the packet identifier.

The broadcasting apparatus 100 includes a storage-type program processing unit 106. The storage-type program processing unit 106 is connected to the program DB 102. Under the control of the program delivery management unit 110, the storage-type program processing unit 106 obtains a program from the program DB 102 according to a program delivery schedule. The storage-type program processing unit 106 encodes the program obtained from the program DB 102 for storage-type broadcasting. For example, for multimedia broadcasting, the storage-type program processing unit 106 may convert the program into a File Delivery over Unidirectional Transport (FLUTE) packet. In FLUTE, a file delivery table (FDT) is delivered with object ID (TOI)=0. The FDT contains attributes of one or more electronic files to be delivered. The FDT is received via a unidirectional channel. In the FDT, attribute information such as a file name, an object ID, a file type, a compression type, a data length, and a URL is written in Extensible Markup Language (XML) for one or more electronic files. The attribute information may be encrypted or not encrypted. In the present embodiment, it is assumed that the attribute information is encrypted. After delivering the FDT, the storage-type program processing unit 106 divides the electronic files into packets for delivery. For example, the storage-type program processing unit 106 delivers an electronic file 1 with object ID=1 after dividing the electronic file 1 into plural packets, and then delivers an electronic file 2 with object ID=2 after dividing the electronic file 2 into plural packets. The electronic files are received via a unidirectional channel. The receiving device 300 decodes the received electronic files, assembles the decoded electronic files, and sends the assembled electronic files to an appropriate application(s) by referring to the file delivery table received in advance.

The broadcasting apparatus 100 includes a broadcast multiplexing unit 108. The broadcast multiplexing unit 108 is connected to the streaming program processing unit 104 and the storage-type program processing unit 106. The broadcast multiplexing unit 108 multiplexes encoded data input from the streaming program processing unit 104 and encoded data input from the storage-type program processing unit 106. The multiplexed encoded data are output as a broadcast signal. For example, for multimedia broadcasting, the multiplexed encoded data are output as a broadcast signal after conversion into transport streams and OFDM modulation.

The broadcasting apparatus 100 includes the program delivery management unit 110. The program delivery management unit 110 formulates program delivery schedules. Also, the program delivery management unit 110 centrally controls the program DB 102, the streaming program processing unit 104, and the storage-type program processing unit 106.

In the broadcasting apparatus 100, the program DB 102, the streaming program processing unit 104, the storage-type program processing unit 106, and the program delivery management unit 110 are connected to each other via a bus 150.

### <Broadcast Server>

The broadcast server 200 includes a data communication unit 202. The data communication unit 202 performs data communications with the receiving device 300. The data communication unit 202 may perform data communications via a two-way network. For example, the data communication unit 202 may perform communications via the Internet or a mobile communication network.

When receiving the ID of the receiving device 300 and a program ID of a program to be purchased from the receiving device 300, the data communication unit 202 inputs the ID of the receiving device 300 and the program ID of the program to be purchased to a program charge processing unit 204. Also, when receiving the ID of the receiving device 300, a PPV program ID, and reception condition information indicating the reception condition from the receiving device 300, the data communication unit 202 inputs the ID of the receiving device 300, the PPV program ID, and the reception condition information to a data use determining unit 208. Further, the data communication unit 202 sends a view right input from the data use determining unit 208 and a delivery schedule to the receiving device 300.

The broadcast server 200 includes the program charge processing unit 204. In response to a purchase request from the receiving device 300, the program charge processing unit 204 performs a charging process for a PPV program. For example, the program charge processing unit 204 receives the ID of the receiving device 300 and a program ID of a program to be purchased. The program charge processing unit 204 charges the user of the receiving device 300 for the program corresponding to the program ID. After charging for the program corresponding to the program ID, the program charge processing unit 204 reports the ID of the charged receiving device 300 and the program ID of the charged program to a purchase history management unit 206.

The broadcast server 200 includes the purchase history management unit 206. The purchase history management unit 206 manages and stores a purchase history of PPV programs for each receiving device. For example, when the ID of the charged receiving device 300 and the program ID of the charged program are reported from the program charge processing unit 204, the purchase history management unit 206 stores the ID of the receiving device 300 and the program ID of the charged program in association with each other.

The broadcast server 200 includes the data use determining unit 208. When receiving the ID of the receiving device 300, a PPV program ID, and reception condition information from the receiving device 300, the data use determining unit 208 determines whether it is necessary to make a program corresponding to the PPV program ID viewable (i.e., to enable the user to view the program again).

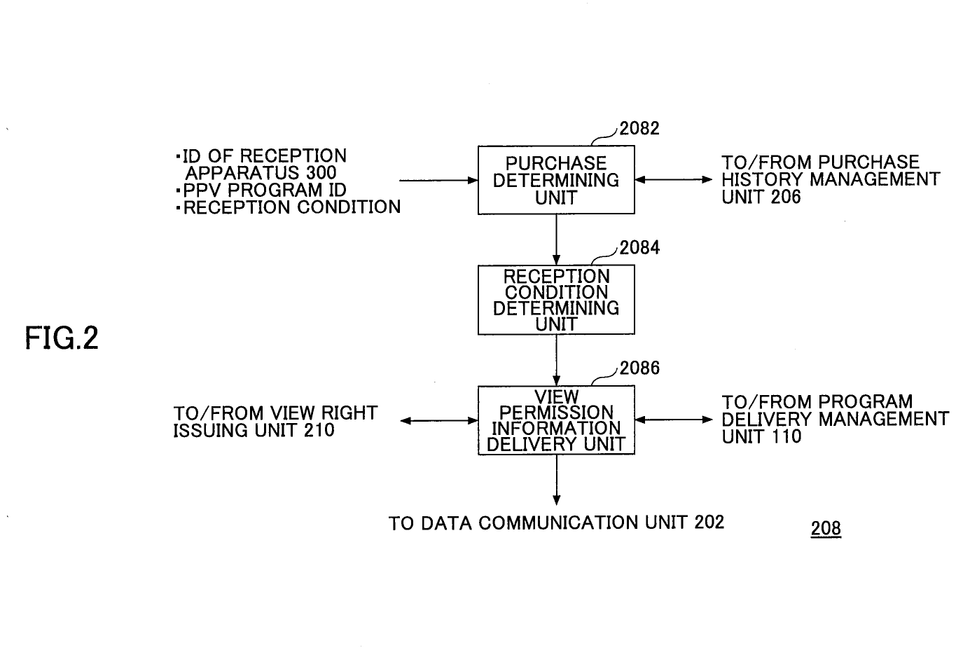

FIG. 2 is a functional block diagram of the data use determining unit 208.

The data use determining unit 208 includes a purchase determining unit 2082. The purchase determining unit 2082 receives the PPV program ID, the ID of the receiving device 300, and the reception condition. The purchase determining unit 2082 determines whether the program corresponding to the PPV program ID has been purchased by the user of the receiving device 300. For example, the purchase determining unit 2082 determines whether the program corresponding to the PPV program ID has been purchased by referring to the purchase history of programs stored for each receiving device in the purchase history management unit 206. If the program has been purchased, the purchase determining unit 2082 inputs the ID of the receiving device 300, the PPV program ID, and the reception condition to a reception condition determining unit 2084.

For example, the reception condition may include at least one of the start time and end time of viewing the PPV program (PPV-program-viewing start and end times), the number of packets or the amount of data, the number of received entitlement control messages (ECM), a reception rate, and a normal viewing time.

The ECM includes information on a program, key information (scramble key) for descrambling the program, and control information to forcibly enable or disable a descrambling function of the receiving device 300. The ECM may be called common information.

The reception rate indicates the percentage of time for which video and audio have been normally received in the time from the start to the end of a PPV program. Whether a program has been normally received may be determined based on, for example, a field intensity, a carrier to noise ratio (C/N), and/or time for which packets have been received without an error.

The normal viewing time indicates the amount of time for which video and audio have been normally received between the start and end of a PPV program. Whether a program has been normally received may be determined based on, for example, a field intensity, a carrier to noise ratio (C/N), and/or time for which packets have been received without an error.

The data use determining unit 208 includes the reception condition determining unit 2084. The reception condition determining unit 2084 is connected to the purchase determining unit 2082. When the purchase determining unit 2082 determines that the program corresponding to the PPV program ID has been purchased and inputs the reception condition to the reception condition determining unit 2084, the reception condition determining unit 2084 determines whether the program has been normally viewed at the receiving device 300 based on the reception condition. Alternatively, the reception condition determining unit 2084 may be configured to determine whether the program has been normally recorded at the receiving device 300.

For example, the reception condition determining unit 2084 determines, based on the reception condition of the program, whether the program has been normally viewed at the receiving device 300.

When the reception condition is represented by PPV-program-viewing start and end times, the reception condition determining unit 2084 determines whether the PPV-program-viewing start and end times match the start and end times of the purchased program. When the PPV-program-viewing start and end times match the start and end times of the purchased program, the reception condition determining unit 2084 determines that the program has been normally received. Otherwise, the reception condition determining unit 2084 determines that the program has not been normally received. A tolerable time may be set and used in determining whether a program has been normally received. In this case, the reception condition determining unit 2084 determines that the program has been normally received when the amount of time indicated by the differences between the PPV-program-viewing start and end times and the start and end times of the purchased program is less than or equal to the tolerable time.

When the reception condition is represented by the number of packets or the amount of data, the reception condition determining unit 2084 determines whether the number of packets or the amount of data is greater than or equal to a predetermined packet number/data amount threshold. The amount of data may indicate the amount of data sent from the broadcasting apparatus 100, and the number of packets may indicate the number of packets received by the receiving device 300. The number of packets or the amount of data may be represented by a loss rate of packets. When the number of packets or the amount of data is greater than or equal to the packet number/data amount threshold, the reception condition determining unit 2084 determines that the program has been normally received. Meanwhile, when the number of packets or the amount of data is less than the packet number/data amount threshold, the reception condition determining unit 2084 determines that the program has not been normally received.

When the reception condition is represented by the number of received ECMs, the reception condition determining unit 2084 determines whether the number of received ECMs is greater than or equal to a predetermined received number threshold. When the number of received ECMs is greater than or equal to the received number threshold, the reception condition determining unit 2084 determines that the program has been normally received. Meanwhile, when the number of received ECMs is less than the received number threshold, the reception condition determining unit 2084 determines that the program has not been normally received. Instead of the received number of ECMs, an ECM reception rate may be used. The ECM reception rate may be obtained, for example, by the following formula: (the number of received ECMs reported by the receiving device 300)/(the number of transmitted ECMs). When the ECM reception rate is greater than or equal to a predetermined ECM reception rate threshold, the reception condition determining unit 2084 determines that the program has been normally received. Meanwhile, when the ECM reception rate is less than the ECM reception rate threshold, the reception condition determining unit 2084 determines that the program has not been normally received.

When the reception condition is represented by the reception rate, the reception condition determining unit 2084 determines whether the reception rate is greater than or equal to a predetermined reception rate threshold. When the reception rate is greater than or equal to the reception rate threshold, the reception condition determining unit 2084 determines that the program has been normally received. Meanwhile, when the reception rate is less than the reception rate threshold, the reception condition determining unit 2084 determines that the program has not been normally received.

When the reception condition is represented by the normal viewing time, the reception condition determining unit 2084 determines whether the normal viewing time is greater than or equal to a predetermined normal viewing time threshold. When the normal viewing time is greater than or equal to the normal viewing time threshold, the reception condition determining unit 2084 determines that the program has been normally received. Meanwhile, when the normal viewing time is less than the normal viewing time threshold, the reception condition determining unit 2084 determines that the program has not been normally received.

Based on the result of determining whether the program has been normally received, the reception condition determining unit 2084 determines whether it is necessary to make the program corresponding to the PPV program ID viewable. For example, when it is determined that the program has not been normally received, the reception condition determining unit 2084 determines that it is necessary to make the program corresponding to the PPV program ID viewable. Meanwhile, when it is determined that the program has been normally received, the reception condition determining unit 2084 determines that it is not necessary to make the program corresponding to the PPV program ID viewable. When it is necessary to make the program corresponding to the PPV program ID viewable, the reception condition determining unit 2084 requests a view permission information delivery unit 2086 to make the program corresponding to the PPV program ID viewable.

The data use determining unit 208 includes the view permission information delivery unit 2086. The view permission information delivery unit 2086 is connected to the reception condition determining unit 2084. According to the request from the reception condition determining unit 2084 to make the program corresponding to the PPV program ID viewable, the view permission information delivery unit 2086 makes the program corresponding to the PPV program ID viewable. For example, the view permission information delivery unit 2086 requests a view right for the program corresponding to the PPV program ID from a view right issuing unit 210. In response to the request from the view permission information delivery unit 2086, the view right issuing unit 210 inputs the view right to the view permission information delivery unit 2086. Also, the view permission information delivery unit 2086 requests a delivery schedule from the program delivery management unit 110. In response to the request from the view permission information delivery unit 2086, the program delivery management unit 110 inputs the delivery schedule to the view permission information delivery unit 2086.

The view permission information delivery unit 2086 sends the view right and the delivery schedule to the receiving device 300. For example, the view permission information delivery unit 2086 returns the view right and the delivery schedule to the receiving device 300 in response to the ID of the receiving device 300, the PPV program ID, and the reception condition. For example, the view permission information delivery unit 2086 inputs the view right and the delivery schedule to the data communication unit 202. The data communication unit 202 sends the view right and the delivery schedule to the receiving device 300. The data communication unit 202 may send the view right and the delivery schedule via a two-way network.

The delivery schedule may include, for example, program identification information such as a program ID, identification information of a session for delivering the program via FLUTE, delivery start time, and delivery end time.

The broadcast server 200 includes the view right issuing unit 210. The view right issuing unit 210 issues view rights for file-based content (PPV programs). For example, the view right issuing unit 210 issues a view right for a program corresponding to a PPV program ID in response to a request from the view permission information delivery unit 2086. The view right issuing unit 210 may be configured to obtain ID information of a key for encrypting the program and/or information on the key from the program delivery management unit 110 when issuing the view right. The view right issuing unit 210 inputs the view right to the view permission information delivery unit 2086.

### <View Right>

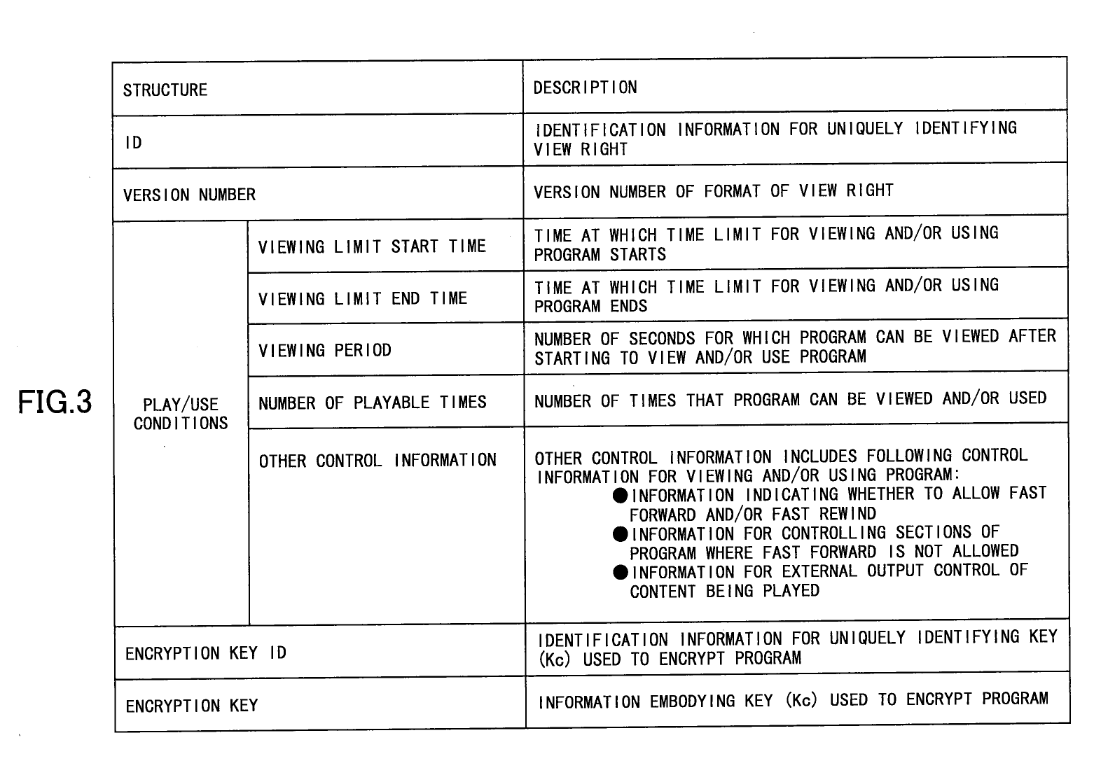

FIG. 3 is a table illustrating exemplary information in a view right. File-based content may be encrypted and transmitted from the broadcasting apparatus 100 to the receiving device 300. In this case, the view right includes an encryption key used to decrypt the encrypted file-based content. The view right also includes information on use conditions for playing and using the file-based content. With the use conditions included in the view right, the receiving device 300 can play and use the file-based content according to the use conditions.

The view right also includes an ID, a version number, play/use conditions, an encryption key ID, and an encryption key.

The ID is identification information for uniquely identifying the view right.

The version number indicates the version of the format of the view right.

The play/use conditions include a viewing limit start time, a viewing limit end time, a viewing period, a number of playable times, and other control information.

The viewing limit start time indicates a time at which the time limit for viewing and/or using the program starts.

The viewing limit end time indicates a time at which the time limit for viewing and/or using the program ends.

The viewing period indicates a period of time for which the program can be viewed after starting to view and/or use the program. The viewing period may be represented by seconds, minutes, and/or hours.

The number of playable times indicates the number of times that the program can be viewed and/or used.

The other control information includes control information for viewing and/or using the program other than the viewing limit start time, the viewing limit end time, the viewing period, and the number of playable times. For example, the other control information may include information indicating whether to allow fast forward and/or fast rewind. Also, the other information may include information for controlling sections of the program where fast forward is not allowed. Further, the other information may include information for external output control of content being played.

The encryption key ID is identification information for uniquely identifying a key (Kc) used to encrypt the program.

The encryption key is information embodying the key (Kc) used to encrypt the program.

In the broadcast server 200, the data communication unit 202, the program charge processing unit 204, the purchase history management unit 206, the data use determining unit 208, and the view right issuing unit 210 are connected to each other via a bus 250.

### <Receiving Device>

The receiving device 300 includes a tuner 302. The tuner 302 receives and demodulates a broadcast signal. The broadcast signal may include a streaming broadcast and file-typed content. The tuner 302 inputs the demodulated broadcast signal to a separation unit 304.

The receiving device 300 includes the separation unit 304. The separation unit 304 is connected to the tuner 302. The separation unit 304 separates the signal input from the tuner 302 into streaming data and storage-type data. For example, the signal input to the tuner 302 includes an MPEG-2 TS. The separation unit 304 inputs the streaming data to a decoding unit 306. When the program is to be recorded, the separation unit 304 inputs the streaming data to a storage processing unit 308. The separation unit 304 inputs the storage-type data to the storage processing unit 308.

The receiving device 300 includes the decoding unit 306. The decoding unit 306 decodes the streaming data input from the separation unit 304. The decoding unit 306 inputs the decoded streaming data to a display processing unit 310. The decoded streaming data include video and audio of the program corresponding to the PPV program ID. The decoding unit 306 also decodes the storage-type data input from the storage processing unit 308. In other words, the decoding unit 306 decodes file-based content. The decoding process includes decryption of encrypted data. The decoding unit 306 inputs the decoded storage-type data to the display processing unit 310. The decoded storage-type data include video and audio of the program corresponding to the PPV program ID.

The receiving device 300 includes the storage processing unit 308. The storage processing unit 308 is connected to the separation unit 304. The storage processing unit 308 performs a recording process for recording streaming data (PPV program) input from the separation unit 304. The storage processing unit 308 also performs a storage process for storing storage-type data. In other words, the storage processing unit 308 performs a storage process for storing file-based content. The storage process may be performed according to a schedule on which the broadcasting apparatus 100 delivers a program.

The receiving device 300 includes the display processing unit 310. The display processing unit 310 plays decoded streaming data or decoded storage-type data input from the decoding unit 306 and thereby displays and outputs video and audio.

The receiving device 300 includes a memory 312. The memory 312 stores programs stored by the storage processing unit 308. The stored programs include recorded programs and file-based content. The memory 312 also stores reception conditions. The reception conditions may be associated with PPV program IDs.

The receiving device 300 includes a program reception management unit 314. The program reception management unit 314 manages program information for streaming broadcasting, program information for storage-type broadcasting, and delivery schedules. The program reception management unit 314 also controls other units of the receiving device 300. Also, the program reception management unit 314 sets a view right and a delivery schedule received from the broadcast server 200 in the corresponding units of the receiving device 300. For example, the program reception management unit 314 sets the view right in a view processing unit 320. With the view right set in the view processing unit 320, the decoding unit 306 can obtain the view right from the view processing unit 320 and decode file-based content based on the view right so that the content can be played. Also, the program reception management unit 314 sets the delivery schedule in the storage processing unit 308. With the delivery schedule set in the storage processing unit 308, the receiving device 300 can receive multimedia broadcasts delivered by the broadcasting apparatus 100 according to the delivery schedule. The program reception management unit 314 also receives a streaming broadcast of a program corresponding to a PPV program ID, and controls processes for viewing and/or recording the program. Further, the program reception management unit 314 controls a storage process for storing file-based content according to a delivery schedule of the file-based content.

The receiving device 300 includes a reception condition measuring unit 316. The reception condition measuring unit 316 measures reception conditions of programs corresponding to PPV program IDs.

Each reception condition measured by the reception condition measuring unit 316 may be represented by PPV-program-viewing start and end times, the number of packets or the amount of data, the number of EOMs, a reception rate, or a normal viewing time.

The reception condition may be measured for each program corresponding to a PPV program ID. After a program corresponding to a PPV program ID ends, the reception condition measuring unit 316 sends the ID of the receiving device 300, the PPV program ID, and a measured reception condition to the broadcast server 200. The reception condition measuring unit 316 inputs the PPV program ID and the reception condition to the data communication unit 318 to send them to the broadcast server 200. The data communication unit 202 may send the ID of the receiving device 300, the PPV program ID, and the reception condition via a two-way network. The reception condition measuring unit 316 also inputs the measured reception condition to the memory 312.

The receiving device 300 includes the view processing unit 320. The view processing unit 320 is connected to the data communication unit 318. The view processing unit 320 performs processes for viewing a program.

The view processing unit 320 includes a program purchase processing unit 3202. The program purchase processing unit 3202 communicates with the broadcast server to perform a process for purchasing a broadcast program to be delivered by the broadcasting apparatus 100. For example, the program purchase processing unit 3202 causes the data communication unit 318 to send the ID of the receiving device 300 and a program ID of a program to be purchased to the broadcast server 200. The program ID may indicate an ID of a program that the user requested to purchase.

The view processing unit 320 includes a view right management unit 3204. The view right management unit 3204 obtains view rights of programs corresponding to PPV program IDs, and manages the obtained view rights. The view right may be a right for viewing file-based content. The view right management unit 3204 controls use of file-based content according to the view rights.

The receiving device 300 includes the data communication unit 318. The data communication unit 318 performs data communications with the broadcast server 200. The data communication unit 318 may communicate with the broadcast server via a two-way network.

In the receiving device 300, the tuner 302, the separation unit 304, the decoding unit 306, the storage processing unit 308, the display processing unit 310, the memory 312, the program reception management unit 314, the reception condition measuring unit 316, the data communication unit 318, and the view processing unit 320 are connected to each other via a bus 350.

### <System Operations>

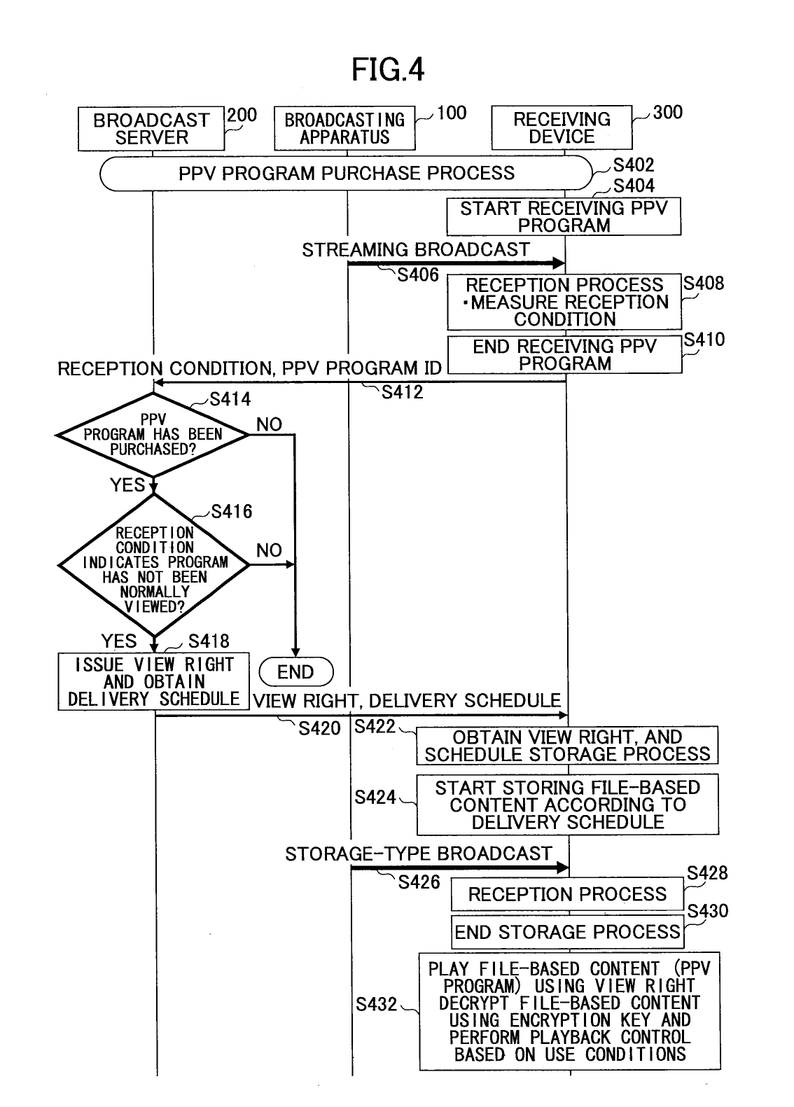

FIG. 4 is a sequence chart illustrating operations of the system.

A PPV program purchase process is performed between the broadcast server 200 and the receiving device 300 (step S402). For example, the program purchase processing unit 3202 sends the ID of the receiving device 300 and a program ID of a program to be purchased to the broadcast server 200. The program charge processing unit 204 performs a charging process for a PPV program in response to a purchase request from the receiving device 300. For example, the program charge processing unit 204 receives, from the receiving device 300, the ID of the receiving device 300 and the program ID of the program to be purchased. The program charge processing unit 204 charges the user of the receiving device 300 for the program corresponding to the program ID.

The receiving device 300 prepares to receive a program corresponding to a PPV program ID (step S404). For example, under the control of the program reception management unit 314, the decoding unit 306 prepares to receive the program corresponding to the PPV program ID. More specifically, the decoding unit 306 waits according to a delivery schedule to decode the program.

The broadcasting apparatus 100 sends a streaming broadcast (step S406). For example, under the control of the program delivery management unit 110, the streaming program processing unit 104 obtains a program from the program DB 102 according to a program delivery schedule. The streaming program processing unit 104 encodes the program obtained from the program DB 102 for streaming broadcasting. The broadcast multiplexing unit 108 multiplexes encoded data input from the streaming program processing unit 104 and encoded data input from the storage-type program processing unit 106, and outputs the multiplexed data as a broadcast signal.

The receiving device 300 receives the streaming broadcast from the broadcasting apparatus 100 (step S408). While receiving the streaming broadcast, the receiving device 300 measures the reception condition of the streaming broadcast. For example, the tuner 302 receives and demodulates a broadcast signal. The separation unit 304 separates the signal input from the tuner 302 into streaming data and storage-type data. The decoding unit 306 decodes the streaming data input from the separation unit 304. The display processing unit 310 plays the decoded streaming data input from the decoding unit 306 and thereby displays and outputs video and audio. The reception condition measuring unit 316 measures the reception condition of the program corresponding to the PPV program ID.

The receiving device 300 ends receiving the PPV program (step S410).

The receiving device 300 sends the reception condition and the PPV program ID of the PPV program to the broadcast server 200 (step S412). For example, after the program corresponding to the PPV program ID ends, the reception condition measuring unit 316 sends the ID of the receiving device 300, the PPV program ID, and the measured reception condition to the broadcast server 200.

The broadcast server 200 determines whether the PPV program has been purchased (step S414). For example, the purchase determining unit 2082 determines whether the program corresponding to the PPV program ID has been purchased by the receiving device 300. For example, the purchase determining unit 2082 determines whether the program corresponding to the PPV program ID has been purchased by referring to the purchase history of programs stored for each receiving device in the purchase history management unit 206.

When the PPV program has not been purchased (NO in step S414), the broadcast server 200 terminates the process. For example, when it is determined that the program corresponding to the PPV program ID has not been purchased by the receiving device 300, the purchase determining unit 2082 inputs nothing to the reception condition determining unit 2084 because it is not necessary to make the program viewable.

When the PPV program has been purchased (YES in step S414), the broadcast server 200 determines whether the reception condition indicates that the program has not been normally viewed (step S416). For example, the purchase determining unit 2082 inputs the ID of the receiving device 300, the PPV program ID, and the reception condition to the reception condition determining unit 2084. Based on the reception condition of the PPV program, the reception condition determining unit 2084 determines whether the program has been normally viewed at the receiving device 300. Based on the result of determining whether the program has been normally received, the reception condition determining unit 2084 determines whether it is necessary to make the program corresponding to the PPV program ID viewable.

When the reception condition indicates that the program has been normally viewed (NO in step S416), the broadcast server 200 terminates the process because it is not necessary to make the program viewable.

When the reception condition indicates that the program has not been normally viewed (YES in step S416), the broadcast server 200 issues a view right (step S418). The broadcast server 200 also obtains a delivery schedule. When it is necessary to make the program corresponding to the PPV program ID viewable, the reception condition determining unit 2084 requests the view permission information delivery unit 2086 to make the program corresponding to the PPV program ID viewable. According to the request from the reception condition determining unit 2084 to make the program corresponding to the PPV program ID viewable, the view permission information delivery unit 2086 makes the program corresponding to the PPV program ID viewable. For example, the view permission information delivery unit 2086 requests a view right for the program corresponding to the PPV program ID from the view right issuing unit 210. In response to the request from the view permission information delivery unit 2086, the view right issuing unit 210 inputs the view right to the view permission information delivery unit 2086. Also, the view permission information delivery unit 2086 requests a delivery schedule from the program delivery management unit 110. In response to the request from the view permission information delivery unit 2086, the program delivery management unit 110 inputs the delivery schedule to the view permission information delivery unit 2086.

The broadcast server 200 sends the view right and the delivery schedule to the receiving device 300 (step S420). For example, the view permission information delivery unit 2086 inputs the view right and the delivery schedule to the data communication unit 202. The data communication unit 202 sends the view right and the delivery schedule to the receiving device 300.

The receiving device 300 obtains the view right. According to the delivery schedule, the receiving device 300 schedules a storage process for storing file-based content. The program reception management unit 314 sets the view right and the delivery schedule received from the broadcast server 200 in the corresponding units of the receiving device 300. For example, the program reception management unit 314 sets the view right in the view right management unit 3204. Also, the program reception management unit 314 sets the delivery schedule in the storage processing unit 308.

According to the delivery schedule, the receiving device 300 starts storing the file-based content (step S424). For example, the storage processing unit 308 starts a storage process for storing storage-type data. In other words, the storage processing unit 308 performs a storage process for storing file-based content. The storage process may be performed according to a schedule on which the broadcasting apparatus 100 delivers the program.

The broadcasting apparatus 100 sends a storage-type broadcast (step S426). For example, under the control of the program delivery management unit 110, the storage-type program processing unit 106 obtains the corresponding program from the program DB 102 according to a program delivery schedule. The storage-type program processing unit 106 encodes the program obtained from the program DB 102 for storage-type broadcasting. The broadcast multiplexing unit 108 multiplexes encoded data input from the streaming program processing unit 104 and encoded data input from the storage-type program processing unit 106, and outputs the multiplexed data as a broadcast signal.

The receiving device 300 receives the storage-type broadcast (step S428). For example, the tuner 302 receives and demodulates the broadcast signal. The separation unit 304 separates the signal input from the tuner 302 into streaming data and storage-type data. The storage processing unit 308 also performs a storage process for storing the storage-type data input from the separation unit 304. In other words, the storage processing unit 308 performs a storage process for storing file-based content. The storage process may be performed according to a schedule on which the broadcasting apparatus 100 delivers the program.

The receiving device 300 ends the storage process (step S430).

The receiving device 300 decrypts the file-based content using an encryption key according to the view right. The file-based content decrypted using the encryption key is played according to the use conditions (step S432). For example, the decoding unit 306 obtains the view right from the view right management unit 3204 and decodes the storage-type data input from the storage processing unit 308. In other words, the decoding unit 306 decodes file-based content. The decoding process includes decryption of encrypted data. The decoding unit 306 inputs the decoded storage-type data to the display processing unit 310. The decoded storage-type data include video and audio of the program corresponding to the PPV program ID. The display processing unit 310 plays the decoded file-based content input from the decoding unit 306 and thereby displays and outputs video and audio.

In step S420 of the flowchart in FIG. 4, transmission of the delivery schedule may be omitted. When transmission of the delivery schedule is omitted, the receiving device 300 searches a program delivery schedule to determine a time when the program to which the view right is assigned is to be delivered, and receives the file-based content delivered by the broadcasting apparatus 100 at the determined time. Accordingly, sending the delivery schedule from the broadcast server 200 makes it possible to reduce the processing load of the receiving device 300 in determining the time when the file-based content to which the view right is assigned is to be delivered.

In the present embodiment, the reception condition of the program corresponding to the PPV program ID may be measured for each predetermined number of segments. When the reception condition is measured for each of a predetermined number of segments, the receiving device 300 may be configured to report the reception condition to the broadcast server 200 for each of the segments. The broadcast server 200 may be configured to analyze the reception condition for each of the segments. When the reception condition is analyzed for each of the segments, the broadcast server 200 may be configured to send the delivery schedule and the view right only for segments that are determined to be made viewable. In this case, the receiving device can view only those segments that have not been viewed normally.

In the present embodiment, when a program corresponding to a PPV program ID includes segments corresponding to content other than the main story, the reception condition of those segments may not be measured. Examples of the content other than the main story may include a trailer and a commercial message (CM). It is possible to reduce the processing load of the receiving device by not measuring the reception condition of segments corresponding to the content other than the main story. Each segment may correspond to a predetermined period of time. Alternatively, each segment may correspond to a chapter. Information on segments may be multiplexed with the program as additional information for the program.

In a prepaid PPV streaming service, the broadcast server of the present embodiment sends file-based content and a view right to the receiving device when it is determined that a PPV-charged program has not been normally viewed due to the reception condition of a streaming broadcast. With the file-based content and the view right sent to the receiving device, the user can reliably use purchased content. In other words, this configuration enables the user to reliably view a desired program without paying an additional fee.

Since a program is delivered as file-based content, it is possible to perform error correction, time interleaving, and multiple delivery. This in turn makes it possible to reliably deliver a program even when the reception condition is unstable. Also, using file-based content makes it possible to deliver a program in a time period where streaming broadcasting is not being performed. For example, file-based content may be delivered during late night hours. Using a time period where streaming broadcasting is not being performed makes it possible to efficiently use broadcast bands.

### <Variations>

The system of the above embodiment may be modified such that the receiving device 300 determines whether a program has been normally viewed based on the reception condition of the program.

### <System>

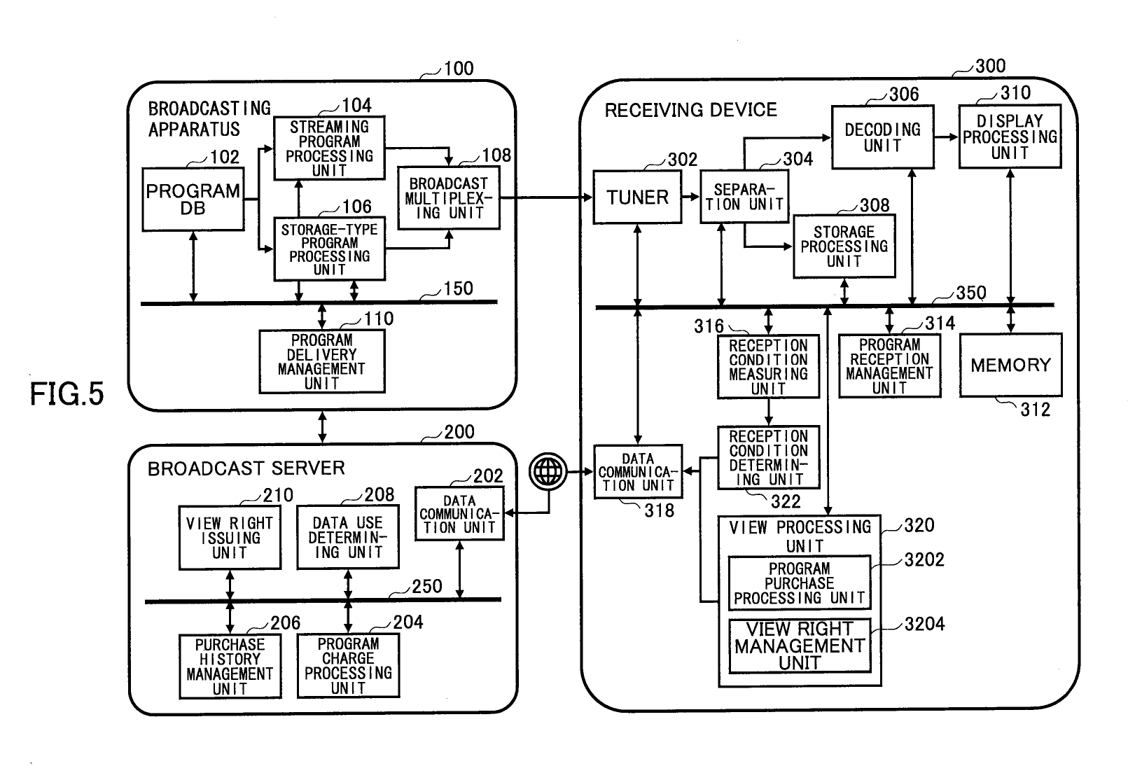

FIG. 5 is a drawing illustrating an exemplary system according to the variation. The system of FIG. 5 is different from the system of FIG. 1 in the processes performed by the data use determining unit 208 and the receiving device 300.

### <Broadcast Server>

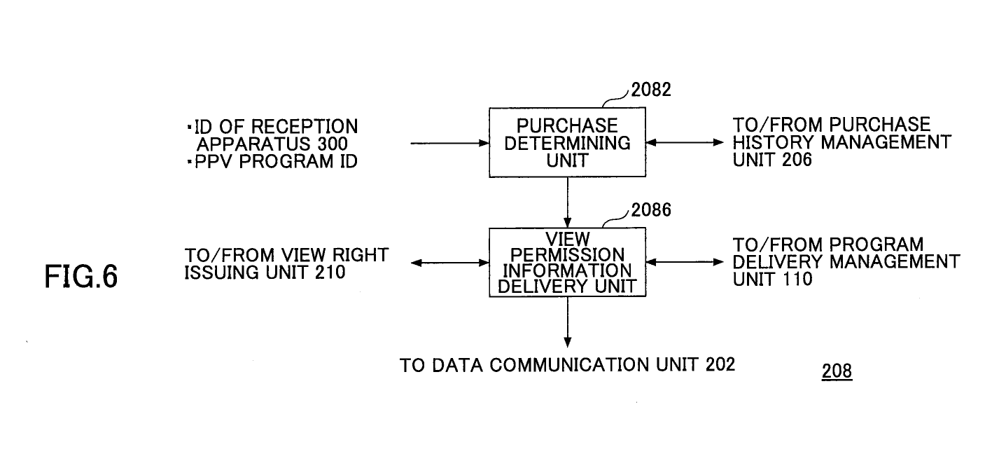

FIG. 6 is a functional block diagram of the data use determining unit 208 of the broadcast server 200.

The data use determining unit 208 includes the purchase determining unit 2082. The purchase determining unit 2082 receives a PPV program ID and the ID of the receiving device 300. The reception condition may not be necessary. The purchase determining unit 2082 determines whether the program corresponding to the PPV program ID has been purchased by the receiving device 300. For example, the purchase determining unit 2082 determines whether the program corresponding to the PPV program ID has been purchased by referring to the purchase history of programs stored for each receiving device in the purchase history management unit 206. When the program has been purchased, the purchase determining unit 2082 inputs the ID of the receiving device 300 and the PPV program ID to the view permission information delivery unit 2086.

The data use determining unit 208 includes the view permission information delivery unit 2086. The view permission information delivery unit 2086 is connected to the purchase determining unit 2082. Based on the ID of the receiving device 300 and the PPV program ID input from the purchase determining unit 2082, the view permission information delivery unit 2086 enables the user to view the program corresponding to the PPV program ID. For example, the view permission information delivery unit 2086 requests a view right for the program corresponding to the PPV program ID from the view right issuing unit 210. In response to the request from the view permission information delivery unit 2086, the view right issuing unit 210 inputs the view right to the view permission information delivery unit 2086. The view permission information delivery unit 2086 may also request a delivery schedule from the program delivery management unit 110. In response to the request from the view permission information delivery unit 2086, the program delivery management unit 110 inputs the delivery schedule to the view permission information delivery unit 2086.

The view permission information delivery unit 2086 sends the view right to the receiving device 300. The view permission information delivery unit 2086 may also send the delivery schedule to the receiving device 300. For example, the view permission information delivery unit 2086 inputs the view right to the data communication unit 202. The view permission information delivery unit 2086 may also input the delivery schedule to the data communication unit 202. The data communication unit 202 sends the view right to the receiving device 300. The data communication unit 202 may also send the delivery schedule to the receiving device 300. The data communication 202 may send the view right and the delivery schedule via a two-way network.

### <Receiving Device>

The receiving device 300 of this variation includes a reception condition determining unit 322 in addition to the components of the receiving device 300 illustrated in FIG. 1. The reception condition determining unit 322 is connected to the reception condition measuring unit 316 and the data communication unit 318.

The reception condition measuring unit 316 measures reception conditions of programs corresponding to PPV program IDs.

Each reception condition measured by the reception condition measuring unit 316 may be represented by PPV-program-viewing start and end times, the number of packets or the amount of data, the number of ECMs, a reception rate, or a normal viewing time.

The reception condition may be measured for each program corresponding to a PPV program ID. After a program corresponding to a PPV program ID ends, the reception condition measuring unit 316 inputs the ID of the receiving device 300, the PPV program ID, and a measured reception condition to the reception condition determining unit 322.

The reception condition determining unit 322 is connected to the reception condition measuring unit 316. Based on the reception condition input from the reception condition measuring unit 316, the reception condition determining unit 322 determines whether the program has been normally viewed at the receiving device 300. Alternatively, the reception condition determining unit 322 may be configured to determine whether the program has been normally recorded at the receiving device 300.

For example, the reception condition determining unit 322 determines, based on the reception condition of the program, whether the program has been normally viewed at the receiving device 300.

When the reception condition is represented by PPV-program-viewing start and end times, the reception condition determining unit 322 determines whether the PPV-program-viewing start and end times match the start and end times of the purchased program. When the PPV-program-viewing start and end times match the start and end times of the purchased program, the reception condition determining unit 322 determines that the program has been normally received. Otherwise, the reception condition determining unit 322 determines that the program has not been normally received. A tolerable time may be set and used in determining whether a program has been normally received. In this case, the reception condition determining unit 322 determines that the program has been normally received when the amount of time indicated by the differences between the PPV-program-viewing start and end times and the start and end times of the purchased program is less than or equal to the tolerable time.

When the reception condition is represented by the number of packets or the amount of data, the reception condition determining unit 322 determines whether the number of packets or the amount of data is greater than or equal to a predetermined packet number/data amount threshold. The number of packets or the amount of data may be represented by a loss rate of packets. When the number of packets or the amount of data is greater than or equal to the packet number/data amount threshold, the reception condition determining unit 322 determines that the program has been normally received. Meanwhile, when the number of packets or the amount of data is less than the packet number/data amount threshold, the reception condition determining unit 2084 determines that the program has not been normally received.

When the reception condition is represented by the number of received ECMs, the reception condition determining unit 322 determines whether the number of received ECMs is greater than or equal to a predetermined received number threshold. When the number of received ECMs is greater than or equal to the received number threshold, the reception condition determining unit 322 determines that the program has been normally received. Meanwhile, when the number of received ECMs is less than the received number threshold, the reception condition determining unit 322 determines that the program has not been normally received.

When the reception condition is represented by the reception rate, the reception condition determining unit 322 determines whether the reception rate is greater than or equal to a predetermined reception rate threshold. When the reception rate is greater than or equal to the reception rate threshold, the reception condition determining unit 322 determines that the program has been normally received. Meanwhile, when the reception rate is less than the reception rate threshold, the reception condition determining unit 322 determines that the program has not been normally received.

When the reception condition is represented by the normal viewing time, the reception condition determining unit 322 determines whether the normal viewing time is greater than or equal to a predetermined normal viewing time threshold. When the normal viewing time is greater than or equal to the normal viewing time threshold, the reception condition determining unit 322 determines that the program has been normally received. Meanwhile, when the normal viewing time is less than the normal viewing time threshold, the reception condition determining unit 322 determines that the program has not been normally received.

Based on the result of determining whether the program has been normally received, the reception condition determining unit 322 determines whether it is necessary to request the broadcast server 200 to make the program corresponding to the PPV program ID viewable. For example, when it is determined that the program has not been normally received, the reception condition determining unit 322 determines that it is necessary to request the broadcast server 200 to make the program corresponding to the PPV program ID viewable. Meanwhile, when it is determined that the program has been normally received, the reception condition determining unit 322 determines that it is not necessary to request the broadcast server 200 to make the program corresponding to the PPV program ID viewable.

When it is necessary to request the broadcast server 200 to make the program corresponding to the PPV program ID viewable, the reception condition determining unit 322 inputs a view enable request signal to the data communication unit 318. The data communication unit 318 sends the view enable request signal to the broadcast server via, for example, a two-way network.

### <System Operations>

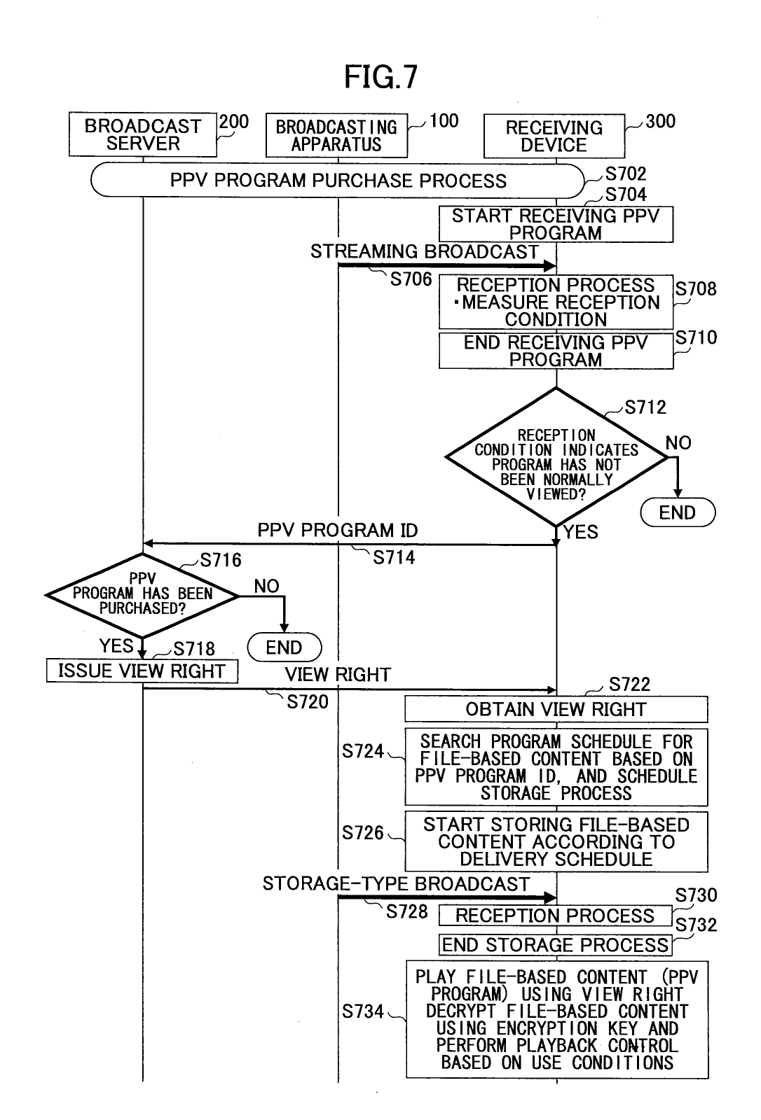

FIG. 7 is a sequence chart illustrating operations of the system.

Steps S702 through S710 of FIG. 7 are substantially the same as steps S402 through S410 of FIG. 4.

The receiving device 300 determines whether the reception condition indicates that the program has not been normally viewed (step S712). For example, the reception condition measuring unit 316 inputs the reception condition to the reception condition determining unit 322. Based on the reception condition of the PPV program, the reception condition determining unit 322 determines whether the program has been normally viewed at the receiving device 300. Based on the result of determining whether the program has been normally received, the reception condition determining unit 322 determines whether it is necessary to request the broadcast server 200 to make the program corresponding to the PPV program ID viewable.

When the reception condition indicates that the program has been normally viewed (NO in step S712), the receiving device 300 terminates the process because it is not necessary to make the program viewable.

When the reception condition indicates that the program has not been normally viewed (YES in step S712), the receiving device 300 determines to request the broadcast server 200 to make the program corresponding to the PPV program ID viewable.

When it is determined to request the broadcast server 200 to make the program corresponding to the PPV program ID viewable, the receiving device 300 sends the ID of the receiving device 300 and the PPV program ID to the broadcast server 200 (step S714). For example, when it is determined to request the broadcast server 200 to make the program corresponding to the PPV program ID viewable, the reception condition determining unit 322 inputs the ID of the receiving device 300 and the PPV program ID to the data communication unit 318. The data communication unit 318 sends the ID of the receiving device 300 and the PPV program ID input from the reception condition determining unit 322 to the broadcast server 200.

The broadcast server 200 determines whether the PPV program has been purchased (step S716). For example, the purchase determining unit 2082 determines whether the program corresponding to the PPV program ID has been purchased by the receiving device 300. For example, the purchase determining unit 2082 determines whether the program corresponding to the PPV program ID has been purchased by referring to the purchase history of programs stored for each receiving device in the purchase history management unit 206.

When the PPV program has not been purchased (NO in step S716), the broadcast server 200 terminates the process. For example, when it is determined that the program corresponding to the PPV program ID has not been purchased by the receiving device 300, the purchase determining unit 2082 inputs nothing to the view permission information delivery unit 2086 because it is not necessary to make the program viewable.

When the PPV program has been purchased (YES in step S716), the broadcast server 200 issues a view right (step S718). The broadcast server 200 may also obtain a delivery schedule. For example, when the program corresponding to the PPV program ID has been purchased, the purchase determining unit 2082 requests the view permission information delivery unit 2086 to make the program corresponding to the PPV program ID viewable. According to the request from the purchase determining unit 2084 to make the program corresponding to the PPV program ID viewable, the view permission information delivery unit 2082 makes the program corresponding to the PPV program ID viewable. For example, the view permission information delivery unit 2086 requests a view right for the program corresponding to the PPV program ID from the view right issuing unit 210. In response to the request from the view permission information delivery unit 2086, the view right issuing unit 210 inputs the view right to the view permission information delivery unit 2086. The view permission information delivery unit 2086 may also request a delivery schedule from the program delivery management unit 110. In response to the request from the view permission information delivery unit 2086, the program delivery management unit 110 inputs the delivery schedule to the view permission information delivery unit 2086.

The broadcast server 200 sends the view right to the receiving device 300 (step S720). The broadcast server 200 may also send the delivery schedule to the receiving device 300. For example, the view permission information delivery unit 2086 inputs the view right to the data communication unit 202. The view permission information delivery unit 2086 may also input the delivery schedule to the data communication unit 202. The data communication unit 202 sends the view right to the receiving device 300. The data communication unit 202 may also send the delivery schedule to the receiving device 300.

The receiving device 300 obtains the view right (step S722). According to the delivery schedule, the receiving device 300 schedules a storage process for storing file-based content (step S724). The program reception management unit 314 sets the view right received from the broadcast server 200 in the corresponding unit of the receiving device 300. The program reception management unit 314 may also set the delivery schedule in the corresponding unit of the receiving device 300. For example, the program reception management unit 314 sets the view right in the view right management unit 3204. The program reception management unit 314 may also set the delivery schedule in the storage processing unit 308.

According to the delivery schedule, the receiving device 300 starts storing the file-based content (step S726). For example, the storage processing unit 308 starts a storage process for storing storage-type data. In other words, the storage processing unit 308 performs a storage process for storing file-based content. The storage process may be performed according to a schedule on which the broadcasting apparatus 100 delivers the program.

Steps S728 through S734 are substantially the same as steps S426 through S432 of FIG. 4.

Thus, in the system of this variation, the reception condition is analyzed at the receiving device. This configuration makes it possible to reduce the processing load of the broadcast server. This configuration also eliminates the need to send information indicating the reception condition from the receiving device 300 to the broadcast server 200, and thereby makes it possible to reduce the network load.

An aspect of this disclosure provides a system including a broadcast server configured to perform a charging process for a program of digital broadcasting, and a terminal apparatus configured to receive the program of digital broadcasting. The terminal apparatus includes a reception condition measuring unit configured to measure a reception condition of the program of digital broadcasting, a reception condition reporting unit configured to report the reception condition of the program measured by the reception condition measuring unit to the broadcast server, and a receiving unit configured to receive, from the broadcast server, information for viewing file-based content of the program to be delivered from a broadcasting apparatus. The broadcast server includes a reception condition determining unit configured to determine whether it is necessary to make the program viewable based on the reception condition of the program reported by the terminal apparatus, a view permission information generating unit configured to generate the information for viewing the file-based content of the program when the reception condition determining unit determines that it is necessary to make the program viewable, and a transmitting unit configured to send the information for viewing the file-based content of the program generated by the view permission information generating unit.

With this configuration, the broadcast server can determine whether a program has been normally viewed based on a streaming reception condition and send a view right for file-based content corresponding to the program to a receiving device when the program has not been normally viewed. Thus, this configuration makes it possible to send the view right for the file-based content corresponding to the program to the receiving device, and thereby enables the user to reliably use the content.

An aspect of this disclosure provides a system including a broadcast server configured to perform a charging process for a program of digital broadcasting, and a terminal apparatus configured to receive the program of digital broadcasting. The terminal apparatus includes a reception condition measuring unit configured to measure a reception condition of the program of digital broadcasting, a reception condition determining unit configured to determine whether it is necessary to request to make the program viewable based on the reception condition of the program measured by the reception condition measuring unit, a program information reporting unit configured to report information indicating the program to the broadcast server when the reception condition determining unit determines that it is necessary to request to make the program viewable, and a receiving unit configured to receive, from the broadcast server, information for viewing file-based content of the program to be delivered from a broadcasting apparatus. The broadcast server includes a view permission information generating unit configured to generate the information for viewing the file-based content of the program based on the information that indicates the program and is reported by the program information reporting unit, and a transmitting unit configured to send the information for viewing the file-based content of the program generated by the view permission information generating unit.

With this configuration, the terminal apparatus can determine whether a program has been normally viewed based on a streaming reception condition, and report the determination result to the broadcast server. When it is reported that the program has not been normally viewed, the broadcast server sends a view right for file-based content corresponding to the program to the receiving device. Thus, this configuration makes it possible to send the view right for the file-based content corresponding to the program to the receiving device, and thereby enables the user to reliably use the content.

The system may also include a purchase determining unit configured to determine whether the program has been purchased. In this case, the view permission information generating unit generates the information for viewing the file-based content of the program when the purchase determining unit determines that the program has been purchased.

This configuration makes it possible to generate information for viewing file-based content of a program and send the information to the terminal apparatus when it is determined that the program reported by the terminal apparatus has been purchased. This configuration makes it possible to prevent a view right from being given to a program that has not been purchased.

The reception condition measuring unit may be configured to measure, as the reception condition, at least one of the viewing start and end times of the program, the number of packets or the amount of data of the program, the number of times that control information for the program has been received, and the amount or percentage of time for which packets have been normally received in the time from the start to the end of the program. In this case, the reception condition determining unit determines whether it is necessary to make the program viewable based on at least one of the viewing start and end times of the program, the number of packets or the amount of data of the program, the number of times that the control information for the program has been received, and the amount or percentage of time for which packets have been normally received in the time from the start to the end of the program.

This configuration makes it possible to determine whether it is necessary to make the program viewable based on the reception condition including at least one of the viewing start and end times of the program, the number of packets or the amount of data of the program, the number of times that the control information for the program has been received, and the amount or percentage of time for which packets have been normally received in the time from the start to the end of the program.

An aspect of this disclosure provides a broadcast server that performs a charging process for a program of digital broadcasting. The broadcast server includes a reception condition determining unit configured to determine whether it is necessary to make the program viewable based on a reception condition reported by a terminal apparatus; a view permission information generating unit configured to generate information for viewing file-based content of the program when the reception condition determining unit determines that it is necessary to make the program viewable; and a transmitting unit configured to send the information for viewing the file-based content of the program generated by the view permission information generating unit. The terminal apparatus is configured to measure the reception condition of the program, report the reception condition to the broadcast server, and receive, from the broadcast server, the information for viewing the file-based content of the program to be delivered from a broadcasting apparatus.

An aspect of this disclosure provides a broadcast server that performs a charging process for a program of digital broadcasting. The broadcast server includes a view permission information generating unit configured to generate information for viewing file-based content of the program based on information that indicates the program and is reported by a terminal apparatus; and a transmitting unit configured to send the information for viewing the file-based content of the program generated by the view permission information generating unit. The terminal apparatus is configured to measure the reception condition of the program, determine whether it is necessary to request to make the program viewable based on the reception condition of the program, report the information indicating the program to the broadcast server when it is necessary to request to make the program viewable, and receive, from the broadcast server, the information for viewing the file-based content of the program to be delivered from a broadcasting apparatus.

An aspect of this disclosure provides a terminal apparatus for receiving digital broadcasting. The terminal apparatus includes a reception condition measuring unit configured to measure a reception condition of a program of digital broadcasting; a reception condition reporting unit configured to report the reception condition of the program measured by the reception condition measuring unit to a broadcast server; and a receiving unit configured to receive, from the broadcast server, information for viewing file-based content of the program to be delivered from a broadcasting apparatus. The broadcast server is configured to determine whether it is necessary to make the program viewable based on the reception condition of the program reported by the terminal apparatus, generate the information for viewing the file-based content of the program when it is necessary to make the program viewable, and send the information for viewing the file-based content of the program.

An aspect of this disclosure provides a terminal apparatus for receiving digital broadcasting. The terminal apparatus includes a reception condition measuring unit configured to measure a reception condition of a program of digital broadcasting; a reception condition determining unit configured to determine whether it is necessary to request to make the program viewable based on the reception condition of the program measured by the reception condition measuring unit; a program information reporting unit configured to report information indicating the program to a broadcast server when the reception condition determining unit determines that it is necessary to request to make the program viewable; and a receiving unit configured to receive, from the broadcast server, information for viewing file-based content of the program to be delivered from a broadcasting apparatus. The broadcast server is configured to generate the information for viewing the file-based content of the program based on the information that indicates the program and is reported by the terminal apparatus, and send the information for viewing the file-based content of the program.

An aspect of this disclosure provides a method for a system including a broadcast server that performs a charging process for a program of digital broadcasting and a terminal apparatus that receives the program of digital broadcasting. The method includes steps performed by the terminal apparatus that include a reception condition measuring step of measuring a reception condition of the program of digital broadcasting, a reception condition reporting step of reporting the reception condition of the program measured in the reception condition measuring step to the broadcast server, and a receiving step of receiving, from the broadcast server, information for viewing file-based content of the program to be delivered from a broadcasting apparatus. The method also includes steps performed by the broadcast server that include a reception condition determining step of determining whether it is necessary to make the program viewable based on the reception condition of the program reported by the terminal apparatus, a view permission information generating step of generating the information for viewing the file-based content of the program when it is determined in the reception condition determining step that it is necessary to make the program viewable, and a transmitting step of sending the information for viewing the file-based content of the program generated in the view permission information generating step.

An aspect of this disclosure provides a method for a system including a broadcast server that performs a charging process for a program of digital broadcasting and a terminal apparatus that receives the program of digital broadcasting. The method includes steps performed by the terminal apparatus that include a reception condition measuring step of measuring a reception condition of the program of digital broadcasting, a reception condition determining step of determining whether it is necessary to request to make the program viewable based on the reception condition of the program measured in the reception condition measuring step, a program information reporting step of reporting information indicating the program to the broadcast server when it is determined in the reception condition determining step that it is necessary to request to make the program viewable, and a receiving step of receiving, from the broadcast server, information for viewing file-based content of the program to be delivered from a broadcasting apparatus. The method also includes steps performed by the broadcast server that include a view permission information generating step of generating the information for viewing the file-based content of the program based on the information that indicates the program and is reported in the program information reporting step, and a transmitting step of sending the information for viewing the file-based content of the program generated in the view permission information generating step.

Although specific values are used in the above descriptions to facilitate the understanding of the present invention, the values are just examples and other appropriate values may also be used unless otherwise mentioned.

The above described embodiments are just examples, and a person skilled in the art may understand that variations and modifications may be made to the above described embodiments. Although functional block diagrams are used to describe apparatuses in the above embodiments, the apparatuses may be implemented by hardware, software, or a combination of them. The present invention is not limited to the specifically disclosed embodiments, and variations and modifications may be made without departing from the scope of the present invention.

The present international application claims priority from Japanese Patent Application No. 2010-145546 filed on Jun. 25, 2010, the entire contents of which are hereby incorporated herein by reference.

### EXPLANATION OF REFERENCES

100 Broadcasting apparatus

102 Program database (DB)

104 Streaming program processing unit

106 Storage-type program processing unit

108 Broadcast multiplexing unit

110 Program delivery management unit

200 Broadcast server

202 Data communication unit

204 Program charge processing unit

206 Purchase history management unit

208 Data use determining unit

2082 Purchase determining unit

2084 Reception condition determining unit

2086 View permission information delivery unit

210 View right issuing unit

300 Receiving device

302 Tuner

304 Separation unit

306 Decoding unit

308 Storage processing unit

310 Display processing unit

312 Memory

314 Program reception management unit

316 Reception condition measuring unit

318 Data communication unit

320 View processing unit

3202 Program purchase processing unit

3204 View right management unit

322 Reception condition determining unit

1. A system, comprising:
a broadcast server configured to perform a charging process for a program of digital broadcasting; and
a terminal apparatus configured to receive the program of digital broadcasting;
wherein the terminal apparatus includes
a reception condition measuring unit configured to measure a reception condition of the program of digital broadcasting,
a reception condition reporting unit configured to report the reception condition of the program measured by the reception condition measuring unit to the broadcast server, and
a receiving unit configured to receive, from the broadcast server, information for viewing file-based content of the program to be delivered from a broadcasting apparatus;
wherein the broadcast server includes
a reception condition determining unit configured to determine whether it is necessary to make the program viewable based on the reception condition of the program reported by the terminal apparatus,
a view permission information generating unit configured to generate the information for viewing the file-based content of the program when the reception condition determining unit determines that it is necessary to make the program viewable, and
a transmitting unit configured to send the information for viewing the file-based content of the program generated by the view permission information generating unit.

2. A system, comprising:
a broadcast server configured to perform a charging process for a program of digital broadcasting; and
a terminal apparatus configured to receive the program of digital broadcasting;
wherein the terminal apparatus includes
a reception condition measuring unit configured to measure a reception condition of the program of digital broadcasting,
a reception condition determining unit configured to determine whether it is necessary to request to make the program viewable based on the reception condition of the program measured by the reception condition measuring unit,
a program information reporting unit configured to report information indicating the program to the broadcast server when the reception condition determining unit determines that it is necessary to request to make the program viewable, and
a receiving unit configured to receive, from the broadcast server, information for viewing file-based content of the program to be delivered from a broadcasting apparatus;
wherein the broadcast server includes
a view permission information generating unit configured to generate the information for viewing the file-based content of the program based on the information that indicates the program and is reported by the program information reporting unit, and
a transmitting unit configured to send the information for viewing the file-based content of the program generated by the view permission information generating unit.

3. The system as claimed in claim 1, further comprising:
a purchase determining unit configured to determine whether the program has been purchased,
wherein the view permission information generating unit is configured to generate the information for viewing the file-based content of the program when the purchase determining unit determines that the program has been purchased.

4. The system as claimed in claim 1, wherein
the reception condition measuring unit is configured to measure, as the reception condition, at least one of viewing start and end times of the program, a number of packets or an amount of data of the program, a number of times that control information for the program has been received, and an amount or percentage of time for which packets have been normally received in time from a start to an end of the program; and
the reception condition determining unit is configured to determine whether it is necessary to make the program viewable based on at least one of the viewing start and end times of the program, the number of packets or the amount of data of the program, the number of times that the control information for the program has been received, and the amount or percentage of time for which packets have been normally received in the time from the start to the end of the program.

5. A broadcast server that performs a charging process for a program of digital broadcasting, the broadcast server comprising:
a reception condition determining unit configured to determine whether it is necessary to make the program viewable based on a reception condition reported by a terminal apparatus;
a view permission information generating unit configured to generate information for viewing file-based content of the program when the reception condition determining unit determines that it is necessary to make the program viewable; and
a transmitting unit configured to send the information for viewing the file-based content of the program generated by the view permission information generating unit,
wherein the terminal apparatus is configured to measure the reception condition of the program, report the reception condition to the broadcast server, and receive, from the broadcast server, the information for viewing the file-based content of the program to be delivered from a broadcasting apparatus.

6. A broadcast server that performs a charging process for a program of digital broadcasting, the broadcast server comprising:
a view permission information generating unit configured to generate information for viewing file-based content of the program based on information that indicates the program and is reported by a terminal apparatus; and
a transmitting unit configured to send the information for viewing the file-based content of the program generated by the view permission information generating unit,
wherein the terminal apparatus is configured to measure the reception condition of the program, determine whether it is necessary to request to make the program viewable based on the reception condition of the program, report the information indicating the program to the broadcast server when it is necessary to request to make the program viewable, and receive, from the broadcast server, the information for viewing the file-based content of the program to be delivered from a broadcasting apparatus.

7. A terminal apparatus for receiving digital broadcasting, the terminal apparatus comprising:
a reception condition measuring unit configured to measure a reception condition of a program of digital broadcasting;
a reception condition reporting unit configured to report the reception condition of the program measured by the reception condition measuring unit to a broadcast server; and
a receiving unit configured to receive, from the broadcast server, information for viewing file-based content of the program to be delivered from a broadcasting apparatus,
wherein the broadcast server is configured to determine whether it is necessary to make the program viewable based on the reception condition of the program reported by the terminal apparatus, generate the information for viewing the file-based content of the program when it is necessary to make the program viewable, and send the information for viewing the file-based content of the program.

8. A terminal apparatus for receiving digital broadcasting, the terminal apparatus comprising:
a reception condition measuring unit configured to measure a reception condition of a program of digital broadcasting;
a reception condition determining unit configured to determine whether it is necessary to request to make the program viewable based on the reception condition of the program measured by the reception condition measuring unit;
a program information reporting unit configured to report information indicating the program to a broadcast server when the reception condition determining unit determines that it is necessary to request to make the program viewable; and
a receiving unit configured to receive, from the broadcast server, information for viewing file-based content of the program to be delivered from a broadcasting apparatus,
wherein the broadcast server is configured to generate the information for viewing the file-based content of the program based on the information that indicates the program and is reported by the terminal apparatus, and send the information for viewing the file-based content of the program.

9. A method for a system including a broadcast server that performs a charging process for a program of digital broadcasting and a terminal apparatus that receives the program of digital broadcasting, the method comprising:
steps performed by the terminal apparatus that include
a reception condition measuring step of measuring a reception condition of the program of digital broadcasting,
a reception condition reporting step of reporting the reception condition of the program measured in the reception condition measuring step to the broadcast server, and
a receiving step of receiving, from the broadcast server, information for viewing file-based content of the program to be delivered from a broadcasting apparatus; and
steps performed by the broadcast server that include
a reception condition determining step of determining whether it is necessary to make the program viewable based on the reception condition of the program reported by the terminal apparatus,
a view permission information generating step of generating the information for viewing the file-based content of the program when it is determined in the reception condition determining step that it is necessary to make the program viewable, and
a transmitting step of sending the information for viewing the file-based content of the program generated in the view permission information generating step.

10. A method for a system including a broadcast server that performs a charging process for a program of digital broadcasting and a terminal apparatus that receives the program of digital broadcasting, the method comprising:
steps performed by the terminal apparatus that include
a reception condition measuring step of measuring a reception condition of the program of digital broadcasting,
a reception condition determining step of determining whether it is necessary to request to make the program viewable based on the reception condition of the program measured in the reception condition measuring step,
a program information reporting step of reporting information indicating the program to the broadcast server when it is determined in the reception condition determining step that it is necessary to request to make the program viewable, and
a receiving step of receiving, from the broadcast server, information for viewing file-based content of the program to be delivered from a broadcasting apparatus; and
steps performed by the broadcast server that include
a view permission information generating step of generating the information for viewing the file-based content of the program based on the information that indicates the program and is reported in the program information reporting step, and
a transmitting step of sending the information for viewing the file-based content of the program generated in the view permission information generating step.

11. The system as claimed in claim 2, further comprising:
a purchase determining unit configured to determine whether the program has been purchased,
wherein the view permission information generating unit is configured to generate the information for viewing the file-based content of the program when the purchase determining unit determines that the program has been purchased.

12. The system as claimed in claim 2, wherein
the reception condition measuring unit is configured to measure, as the reception condition, at least one of viewing start and end times of the program, a number of packets or an amount of data of the program, a number of times that control information for the program has been received, and an amount or percentage of time for which packets have been normally received in time from a start to an end of the program; and
the reception condition determining unit is configured to determine whether it is necessary to make the program viewable based on at least one of the viewing start and end times of the program, the number of packets or the amount of data of the program, the number of times that the control information for the program has been received, and the amount or percentage of time for which packets have been normally received in the time from the start to the end of the program.
